(19) United States
(12) Patent Application Publication
(10) Pub. No.: US 2009/0287601 A1
(43) Pub. Date: Nov. 19, 2009

(54) Network-Based Viral Payment System

(75) Inventors: John Tumminaro, Palo Alto, CA (US); John Michael Tumminaro, Redwood City, CA (US); Christopher A. Paddock, San Francisco, CA (US); David Schwartz, San Francisco, CA (US); Irvin Henderson, Palo Alto, CA (US)

Correspondence Address: Law Offices of James E. Eakin, P.O. Box 1250, Menlo Park, CA, 94026, US

(73) Assignee: OBOPAY, INC., Redwood City, CA (US)

(21) Appl. No.: 12/405,203

(22) Filed: Mar. 16, 2009

Related U.S. Application Data
(63) Continuation of application No. 61/036,866, filed on Mar. 14, 2008.

(51) Int. Cl. G06Q 20/00; G06F 15/16

(52) U.S. Cl. 705/39; 709/206

(57) ABSTRACT

A system and method for transferring funds among registered and unregistered users of a value exchange system comprises a server system for receiving value exchange instructions from a sender, where the value exchange instructions include a recipient who may not be registered with the system. The value exchange instructions initiate a computer-generated sequence for authenticating the identity of the recipient, permitting the recipient to designate a payment method, and transferring funds to properly authenticated recipients.

### RELATED APPLICATIONS

The present application claims the benefit of U.S. patent application Ser. No. 11/694,747, filed Mar. 30, 2007, (hereinafter sometimes referred to as the “'747 application”) as well as U.S. provisional Patent Application Ser. No. 61/036,866, filed Mar. 14, 2008, both of which are incorporated herein in full by reference.

### FIELD OF THE INVENTION

The present invention relates generally to network-based payment systems, and more particularly relates to systems and methods for sending payments across wireless and wired networks to unregistered users.

### BACKGROUND OF THE INVENTION

Financial transactions performed over public networks such as the internet have generally been limited to individuals and businesses that have registered with the service managing the back end of the transaction. Such registered users have been permitted to perform limited types of transactions, but even such limited transaction types have demonstrated the viability of new technologies for performing financial exchanges.

However, the prior art typically has not permitted a registered user desires to engage in a financial exchange with someone who is not registered with the service managing the transaction. In such cases, the unregistered person or entity has been required to register to be able to take part in the transaction or exchange. This can present problems in some significant percentage of instances, either because the unregistered person or entity simply desires not to be registered, or because there are financial or other limitations which prevent registration. The inability of the one party to register has, in the past, at least generally caused the transaction or exchange to fail.

While there are alternatives for sending money, such as services provided by Western Union and others, these services are typically costly and involve having at least the recipient appear in person, among other inconvenient or limiting aspects. This inconvenience makes such transactions unattractive to a significant percentage of those who might otherwise use such a service.

As a result, there has been a need for a convenient, fast, inexpensive system and method which permits users of a financial system to conduct financial transactions or similar exchanges with anyone, whether a registered user of the system or not.

### SUMMARY OF THE INVENTION

The present invention overcomes the limitations of the prior art by providing a system and method by which financial transactions, including remittances, or other exchanges can be conducted between users who are not registered with the system. For convenience, as used hereinafter, “transaction” will be understood to encompass all forms of transactions and exchanges. Likewise, hereinafter “funds” will be used to encompass all forms of value.

The invention further permits the conducting of financial transactions or similar exchanges with individuals who do not maintain an account at a financial institution such as a bank.

To permit such transactions and exchanges to be performed easily and expeditiously, the present invention includes, in some embodiments, the ability for at least one of the parties to the transaction to be unregistered. Such users can engage in a one-time transaction by providing adequate authentication to the system. In some embodiments, the authentication process can be structured as a mini-registration, although in other embodiments greater or lesser levels of authentication can be implemented, and in some cases the authentication data is recorded only long enough to ensure against fraud or other improper transactions. Similarly, in some embodiments the authentication required can vary depending, among other things, upon the nature, size and/or reach of the transaction. For example, if the reach is across international borders, specific forms of authentication may be required whereas transactions not crossing territorial borders may permit more generic forms of identification.

In some embodiments, to perform a transfer, the system and method of the present invention places funds derived either from a system account or a linked account, such as a bank account, shares account, credit card, line of credit, or other funding source, or both, and places those funds in a pooled account while the transaction is being completed. Upon completion, the funds are transferred to the recipient. In other embodiments, the sequence by which the funds are transferred can vary. Likewise, in some embodiments the funds can remain in the sender's account and are transferred directly to the recipient upon the conclusion of the transaction. In still other embodiments, involving other than real-time or near-real time transactions, the system can move the sender's funds to a first pooled account for further handling, and then move the funds to another institution or clearing house in batch mode.

It will also be appreciated that the system of the present invention can automatically invoke, or require a sender to invoke, different types of accounts. Thus, for certain transactions, a sender can register with only limited information, but the same sender, desiring to engage in a different transaction, can be required to provide additional authentication to be able to perform the transaction.

These and other aspects of the present invention can be better appreciated from the following Detailed Description of the Invention, taken in conjunction with the appended Figures as described below.

### THE FIGURES

FIG. 1 illustrates a transaction using a network-based payment system in accordance with an embodiment of the invention.

FIGS. 2 and 3 illustrate a variety of channels for adding (or loading) and removing (or unloading) funds to and from a user's account, and forms part of an embodiment of a system for managing transactions as shown in FIG. 1, where FIG. 3 more particularly shows the relationships with external institutions.

FIGS. 4A-4B illustrate a variety of channels for sending funds to a recipient who is registered in the system, and forms part of an embodiment of a system for managing transactions as shown in FIG. 1, where FIG. 4B more particularly illustrates the relationships with external institutions.

FIGS. 5A-5B illustrate a variety of channels for sending funds to a recipient who is not registered in the system, and forms part of an embodiment of a system for managing transactions as shown in FIG. 1, with FIG. 5B more particularly illustrating the relationships with external institutions.

FIG. 6 illustrates the integration of accounts maintained at external financial institutions into a system in accordance with the present invention that permits delivery of funds to anyone, whether registered or not.

FIG. 7 illustrates a user sign-up process than can involve both system accounts and external accounts maintained at financial institutions.

FIG. 8 illustrates the process for handling pending transactions, where funds are not available in real time or near real time.

FIG. 9 illustrates the process flow for load-send functionality.

FIG. 10 illustrates the process for upgrading from a routing account to a regular account.

FIG. 11 illustrates the flow for adding a bank account to a normal account.

### DETAILED DESCRIPTION OF THE INVENTION

This application incorporates herein in full the disclosure set forth in the '747 application, which describes a system for sending and receiving payments from registered users or members to recipients who may or may not be registered users, together with the disclosures set forth in Appendices B and C.

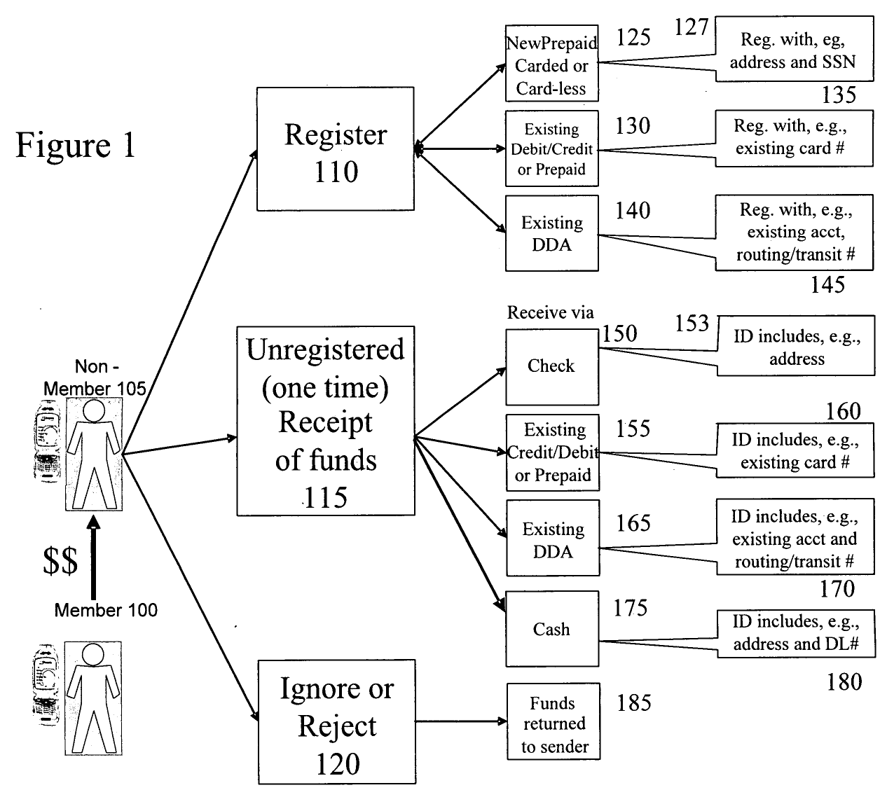

Referring first to FIG. 1, an example of a transaction in accordance with an embodiment of the present invention is illustrated. A member or registered user 100 seeks to send an amount, typically although not necessarily money, to a recipient 105. In the general system described in the '747 application, the recipient can either be a member or registered user, or a non-member or unregistered user. For purposes of the present disclosure, the recipient 105 can be a non-member who is not registered with the system and therefore is not identified as being associated with an account recognizable by the system. Payments to such unregistered users are sometimes referred to in the industry as “viral” payments, and such recipients are sometimes referred to as “viral recipients”.

As discussed in the '747 application, when the sender 100 sends a payment, the system of the present invention communicates to the recipient and also performs various accounting tasks, including, for example, one or more of verifying the availability of funds, debiting the sender's account or placing on hold an appropriate amount of funds in that account, transferring funds to a pooled account, transferring funds to a suspense account, and crediting the recipient's account, if known.

For the present disclosure, where the recipient 105 is not registered, the system cannot map the recipient to an account into which to transfer the funds, but nevertheless communicates to the recipient, such as through a phone number, email address, or other identifier supplied by the sender, that the funds from the sender are available for pick-up. At this point, the recipient is, in accordance with the illustrated embodiment, given choices as to how to receive the funds. The recipient can choose to register, as shown at 110, can choose a method to receive funds without registering, as shown at 115, or can ignore or reject the payment, as shown at 120.

In the event that the viral recipient 105 chooses to register, he can, in accordance with at least some embodiments of the invention, register by providing appropriate information, including, for example, either by identifying a prepaid account he already has, which can but need not include a prepaid card, as shown at 125, or signing up for a new prepaid account during registration. Alternatively, the viral recipient can register by identifying to the system his existing account at a financial institution, such as a credit or debit card account, as shown at 130. In such instances, the registration information will typically comprise a card number and/or other suitable identifiers that uniquely identify the viral recipient to the system, shown at 135. Still further, the viral recipient 105 can choose to register by mapping to a bank account, an investment account, or any other funding source maintained at a financial institution, as shown at 140. If a bank account, this will typically require that the viral recipient provides ACH mapping information, such as routing and transit number, and account number, as shown at 145, although other indicia can be used in some embodiments.

In the event that the viral recipient elects not to register, as shown at 115, the viral recipient can elect to receive a check, as shown at 150, by entering sufficient information to identify to whom and to where the check is to be sent. In some embodiments, a third party clearing service can be used as a drop point for the check. In some embodiments, fees can be charged for having a check prepared and sent. Alternatively, the viral recipient can elect to receive funds via the ACH, as shown at 155, in which case the viral recipient will be required to provide sufficient identifying information, for example account number, routing number, and transit number, as shown at 160, although other information can be used in some embodiments. Further, the viral recipient who elects not to register can receive funds via an existing relationship with a financial institution, for example an existing debit or credit card account as shown at 165. In such an instance, the viral recipient will typically be required to provide sufficient information to uniquely identify the destination of the funds, as shown at 170, such as his card number, and any other identifiers such as CVV, zip code, or other information to ensure the legitimacy of the stated destination.

In the event that the viral recipient either refuses the funds, or ignores the message advising of the funds, the transaction is canceled and the funds are restored to the sender. Typically, the viral recipient is permitted a predetermined time, such as 30 days although the specific period can vary with the implementation, to act on the message before the message is deemed ‘ignored’ and the transaction canceled.

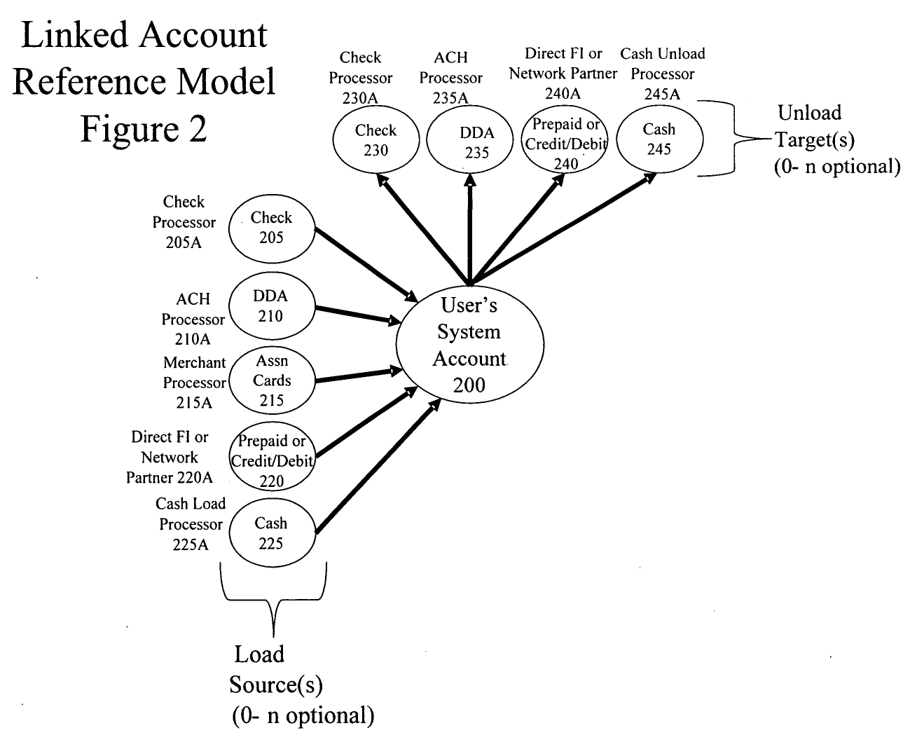

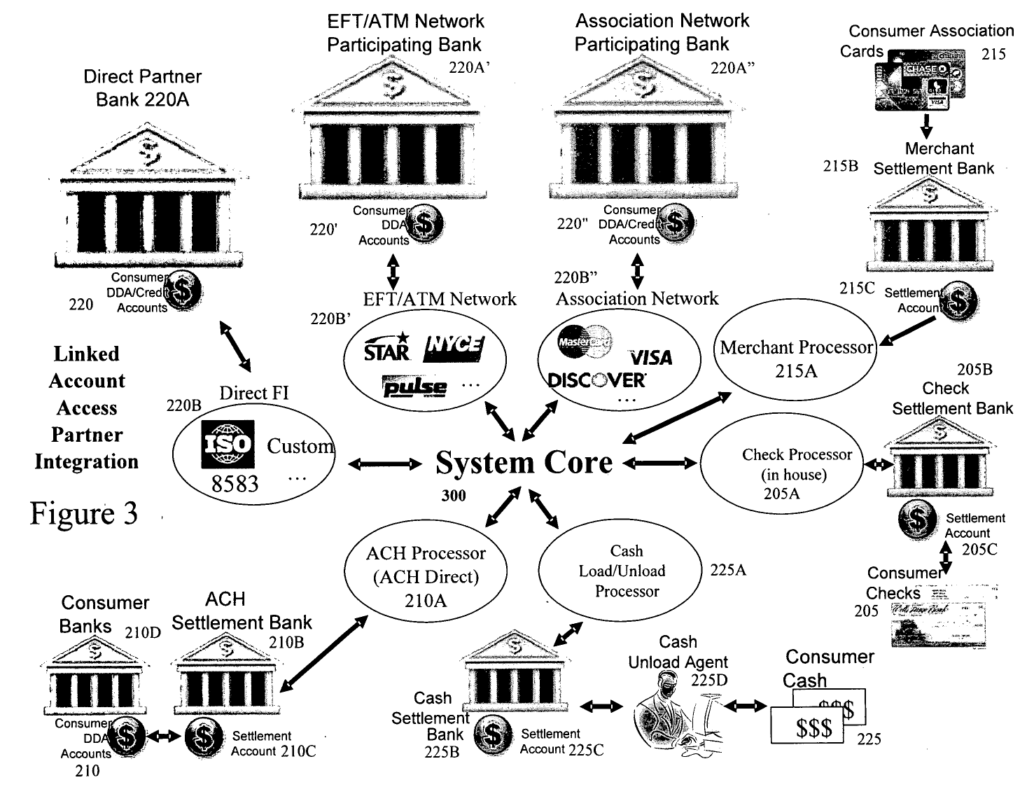

Referring next to FIGS. 2 and 3, an embodiment of a process is illustrated by which a user registered in the system can either add (“load”) money to his system account or remove (“unload”) money from that account. In an embodiment, a user can make funds available to his System Account 200 from one or more sources, including a check 205 processed by a check processor 205A, a DDA transfer 210 managed by an automated clearing house (“ACH”) processor 210A, a credit card transaction 215 managed by a processor 215A, as well as a partner financial institution (FI) which has issued to the user either a credit card or a debit card as shown at 220-220A. In addition, cash transactions 225 can be handled through a cash load processor 225A. This list of possible funding sources is not exhaustive, and need not be limited to cash, currency or credit, but instead can be any value exchange. The user's System Account can be funded from any source of value appropriate for the embodiment. In general, these accounts are considered ‘linked’ to the user's system account for purposes of ‘loading’ or ‘unloading’ funds, and the financial institutions that manage those accounts are typically considered ‘integrated’ into the system of the present invention through banking relationships, network agreements, or other partnering relationships. As used herein, a registered user's account is “mapped” to a bank account or other account if that account has been identified as associated with the registered user, such as during registration. Likewise, the funds can be loaded in one currency, and removed in another, depending upon the embodiment. As will be better appreciated hereinafter, funds can also be sent in one currency, and then delivered to a recipient in another.

Money or other value residing in the user's System Account 200 can be unloaded, that is, sent to the user, through any suitable channel, examples of which are also shown in FIGS. 2 and 3. In an embodiment the owner of an account can receive funds either by means of a check 230, processed through a check processor 230A, or by a DDA transfer 235, handled through an ACH processor 235A, or via a credit/debit card transaction managed by a financial institution, as shown at 240-240A, or with cash 245, handled by a cash unload processor 245A. These examples are given simply for illustration, and are not intended to be the only methods for unloading an account. Likewise, the processors handling unload transactions can but need not be the same as the processors handling load transactions.

Referring particularly to FIG. 3, an embodiment of the integrated system infrastructure for completing the transactions discussed above can be better appreciated. For convenience and clarity, like resources are identified by like numerals, and where a resource performs both load and unload functions, it will be referred to by the load reference numerals and only the load function described even though both functions can be performed, and even though the specific processor, agent or institution can be different for a load than an unload. Thus, a load involving a check 205 includes adding the amount of the check to a settlement account 205C maintained at a settlement financial institution 205B, and processing the check through a check processor 205A, at which point the balance in the user's system account 200 is updated at the system core 300, where the system core 300 comprises servers, databases, messaging systems, etc., as described in the '747 application.

Similarly a load from a demand deposit account (DDA) starts with the user messaging the system core 300 to transfer funds from the user's DDA account 210 maintained at a financial institution 210D. The system core 300 communicates the transfer request to an ACH processor 210A, which communicates with an ACH settlement institution, typically a bank. The settlement bank communicates the funds transfer request to the consumer/merchant (or other user's) bank 210D, which transfers the funds from the user's DDA account 210 into a settlement account 210C maintained at the settlement institution. The user's system account is then updated to reflect the load, and the funds are moved in due course from the settlement account at the settlement bank 210B into other accounts managed by the system of the present invention.

Likewise, a load from an association account 215 comprises a request from the user to the system core 300 to transfer funds. As used herein, an association account refers to an account accessed through a network maintained by an association such as VISA, MasterCard, Discover, American Express, etc., and the particular account can be any type of account made available by a member of that association, such as a credit card account, debit card account, prepaid account, or another type of account. The request is communicated to a merchant processor 215A, which communicates the request to a merchant settlement bank 215B and charges the user's card 215, at which point funds are moved into a settlement account 215C maintained at the merchant settlement bank 215B. The user's system account 200 is updated at the appropriate time, and the funds in the settlement account are settled within the system in due course. Similarly, a request to load funds from a prepaid or credit account 220, 220′ or 220″ maintained either through a direct relationship 220B, an EFT/ATM network 220B′ such as STAR, NYCE or PULSE, or an association network 220B″ such as VISA, MasterCard, etc., begins with a request from the user to load funds from his account, the request is processed either directly (such as in accordance with ISO8583 or other custom protocol) or through the appropriate processor network, and then to the direct partner institution or participating network financial institution. Those skilled in the art will appreciate that the various networks described above differ primarily in the protocols they use and the rules by which transactions are managed, and any type of account can be offered by an institution affiliated with any of the networks shown. Thus, while specific account types are discussed herein in association with different types of networks for purposes of illustration, it will be appreciated that neither the invention nor any embodiment described herein is limited to a particular type of account, a particular type of network or institution, or any combination thereof. A cash load 225 occurs similarly, and can involve a cash load/unload agent 225D to deposit cash funds into a settlement bank 225B, where they are held in a settlement account 225C. The deposit is communicated to a cash load/unload processor 225A, which in turn communicates with the system core 300 to update the user's system account. It will be appreciated that load and unload processes involving the ACH, cash or checks may not occur in real time, while the remaining processes can occur in real time or near-real time. However, through the ACH system, a sender can send funds to any recipient who has an account at any bank that participates in the ACH system, and therefore can be uniquely identified by routing and transit numbers, or other similar indicia. It will also be appreciated that, while the foregoing flow involves both sender and recipient being registered on the system, the recipient may not have been registered at the time the funds were sent, and instead registered as part of the process of receiving those funds.

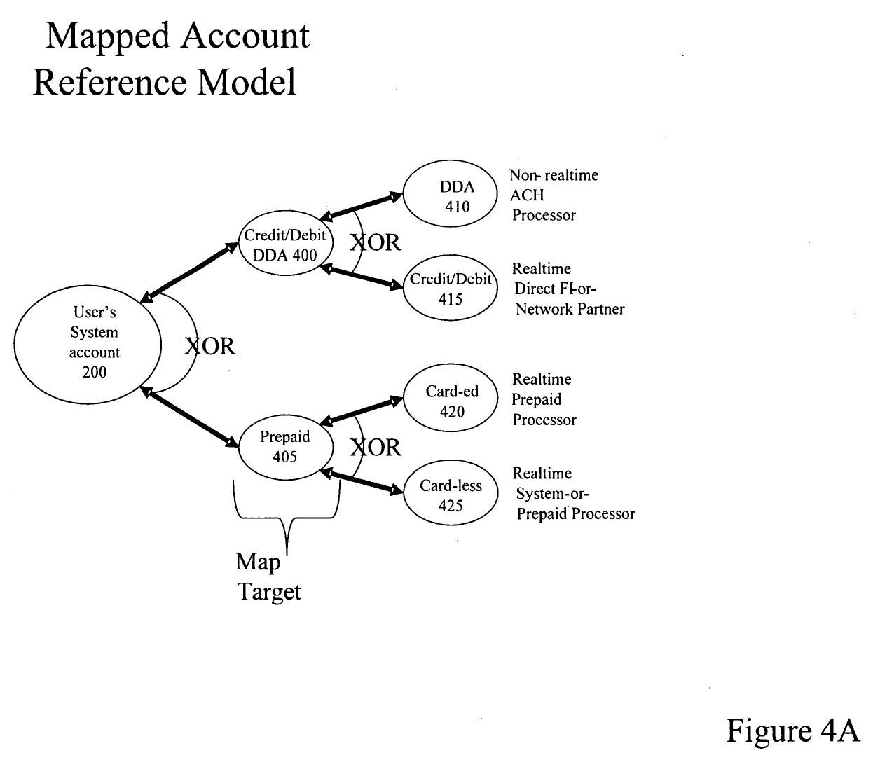

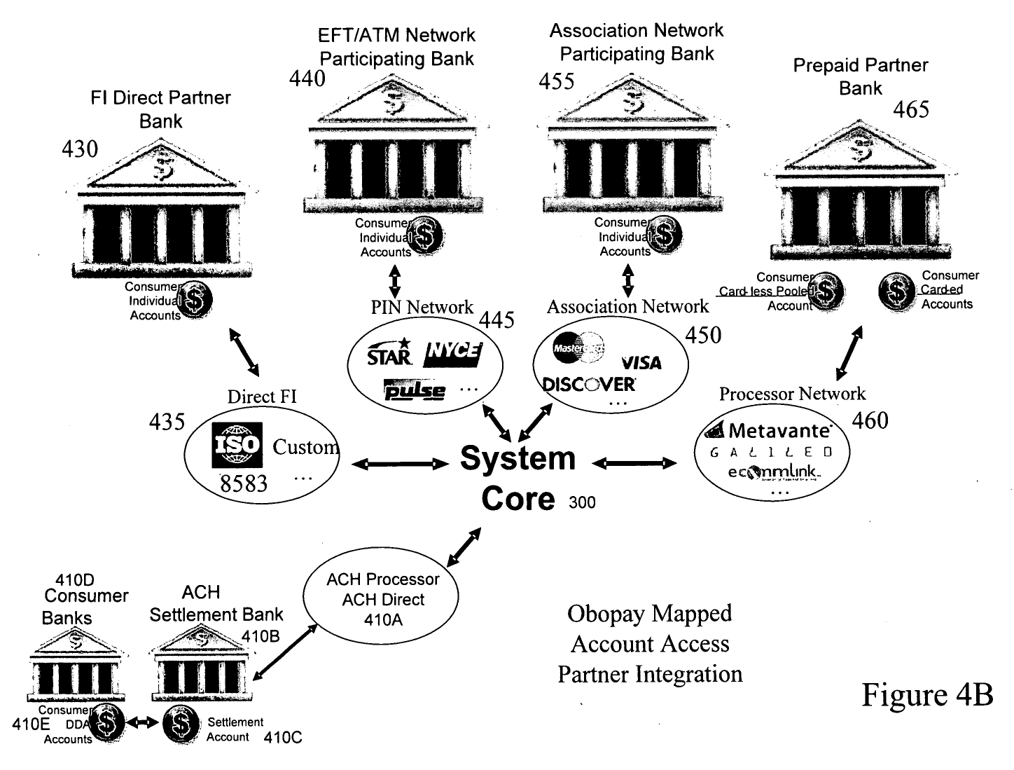

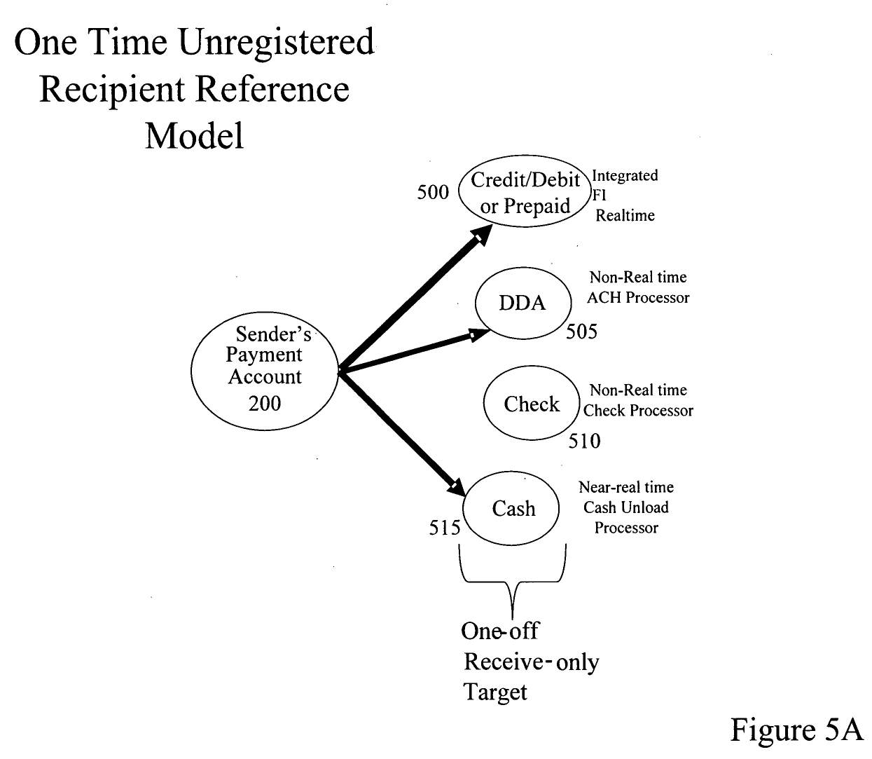

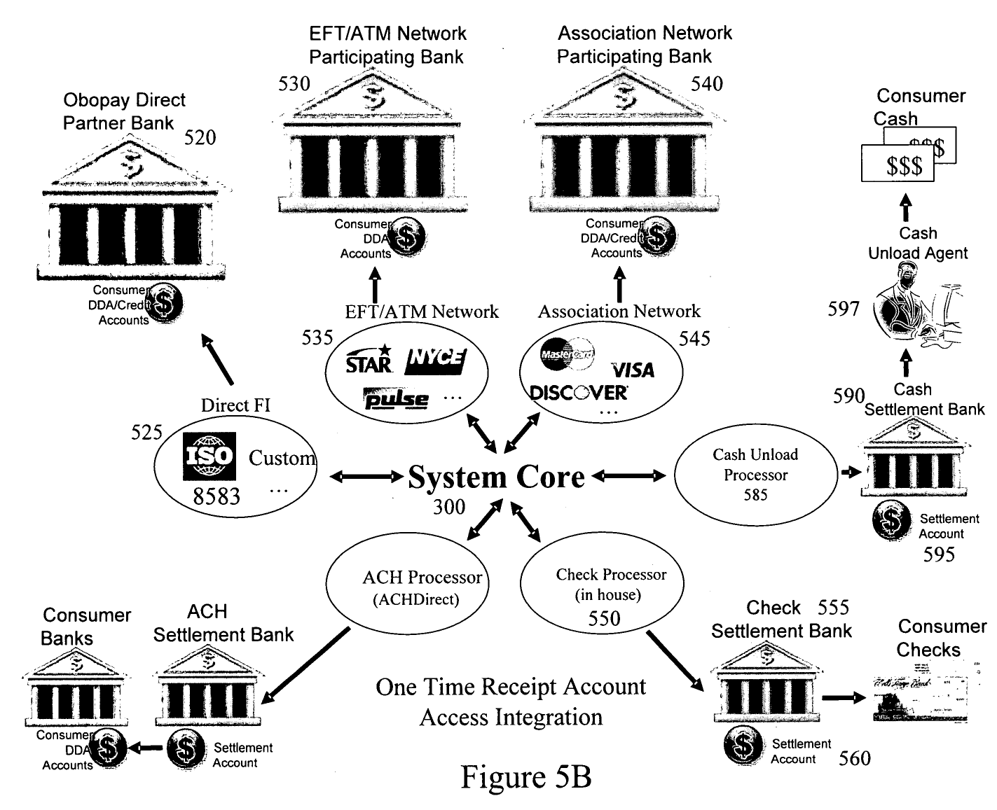

Referring next to FIGS. 4A-4B and 5A-5B, the system and process by which the present invention responds to a request from a user to send money to a recipient can be better appreciated. If the sender is transferring money (or other value) to a recipient, the recipient can, but need not be, registered with the system. The recipient is identified by a phone number or other unique identifier supplied by the sender, as noted above, and the system of the present invention maps that identifier to a recipient's account if the recipient is registered. The recipient's account is typically considered to be connected to the identifier. Thus, the recipient's account can be a pre-paid carded or card-less account, as shown at 240 and 245, or other system account, or it can be an external account 250 maintained either as a DDA account 255 or a debit/credit account 260, or any other type of financial account that can be identified with sufficient specificity that it can be authenticated as a legitimate repository for the recipient's funds. Although certain accounts at financial institutions are described as “external” herein, it will be appreciated that the system of the present invention can be maintained within the same institution as the “external” account, and the “system account” described herein can in some embodiments be integrated directly into one or more “external” accounts.

In a typical arrangement, external DDA accounts are typically accessed through an ACH processor, while debit/credit accounts are typically maintained with a financial institution that is integrated into the system of the present invention. As discussed above, a financial institution that has been integrated into the present system can be thought of as a partner institution, and such integration permits funds transfers to be performed in real-time or near real-time, while funds transfers through the ACH system are not performed in real time.

FIGS. 4A-4B illustrate an embodiment of the infrastructure for sending money to a recipient who has registered with the system, whether as part of the receipt process or previously. Thus, where a user has instructed the system of the present invention to send money to such a recipient, the money can be delivered from the user's system account 200 to the recipient either through a process involving a credit/debit DDA account, indicated at 400, or through a process for a prepaid account, indicated at 405. In an embodiment, only one of these choices is typically selected. If the payment is mapped to a credit/debit/DDA account, and the specific account is a credit/debit account as indicated at 410, the payment is processed in real time or near real time either by a financial institution having a direct connection into the system of the present invention or by a network partner. If the payment is mapped to a DDA account, as indicated at 415, or any other account requiring the use of the ACH system, the payment is processed in accordance with the ACH rules and time periods. It is also possible to transfer funds without going through the ACH to DDA accounts accessible through other banking relationships. If, on the other hand, the payment is mapped to a prepaid account 405, the account can be either card-ed, indicated at 420, or card-less, indicated at 425, or any other type of account offered by the institution, as discussed above. In either event, payments can be processed in real time or near real time either through a prepaid processor or through the system directly.

FIG. 4B illustrates in greater detail the partner integration by which the payment processes outlined in FIG. 4A are executed. Thus, for a payment mapped to a DDA account 410, the system core 300 sends a message to an ACH processor 410A which in turn communicates with an ACH settlement bank 410B, where sufficient funds are maintained in a settlement account 410C. The funds or their equivalent are then transferred to the recipient's bank 410D where they are credited to the recipient's DDA account 410. A transfer to a recipient's credit/debit account 415 can occur in several ways, depending upon whether a direct relationship or a network is involved. If the recipient's account is maintained at a financial institution having a direct connection into the system of the present invention, as indicated at 430, a message is sent from the system core 300 to the bank 430 via a protocol 435 such as ISO 8583 or a custom protocol, and the funds are deposited to the recipient's account in real time or near real time. If the recipient's account is maintained at a bank 440 which participates in an EFT/ATM network 445 such as STAR, NYCE or PULSE, or other network with authentication which is, for example, PIN-based or biometric-based, the funds are transferred to the recipient's account at the bank 440 in accordance with the network rules. Likewise, if the recipient's account is maintained at a bank connected to the network through an association, such as Mastercard, VISA, Discover, or similar, the system core sends a message to the association network 450 and in turn to the participating bank 455 where the recipient's account is maintained. If the recipient's identifier maps to a prepaid account, the system core 300 sends a message to a processor network 460, such as Metavante, Galileo, ecommlink, etc., and the processor network interacts with the appropriate prepaid partner bank 465, where the funds are deposited to the recipient's account, which can be either a card-ed or card-less account. In some embodiments, the accounts can be maintained as pooled accounts.

As noted above, the present invention permits funds to be delivered to anyone, whether or not registered with the system of the present invention, although appropriate verification of identity is required in at least some embodiments. FIG. 5A shows a reference model for a process for delivering funds to an unregistered recipient, where FIG. 5B shows the integration of or other relationship with related financial institutions for ensuring that the funds are delivered to the recipient. As reflected in FIG. 5A, when a user seeks to send funds to an unregistered recipient who elects not to register with the system, in at least some embodiments the recipient is sent a message through the system shown in the '747 application. That message permits the unregistered recipient to choose one of several methods for receiving funds. The recipient can receive the funds in his prepaid, credit or debit card account, or a newly created account, indicated at 500, he can have the funds deposited to an account he maintains at any financial institution connected to the ACH network, indicated at 505, he can elect to receive a check, indicated at 510, or he can elect to receive cash, indicated at 515.

As better shown in FIG. 5B, if the recipient elects to receive his funds through a debit, credit or DDA account maintained at a bank having a direct connection to the system of the present invention, the system core 300 sends a message to the partner bank 520 via a message protocol 525 such as ISO8583 or similar custom profile, and the funds are deposited in real time or near real time to the recipient's account at that institution 520. As discussed in connection with FIG. 1, in at least some embodiments, the recipient is required to provide sufficient information as to permit the system to verify the recipient as the authentic recipient, and also to identify accurately the destination account and to verify the authenticity of that destination. In an embodiment, this information is maintained by the system for verification and anti-fraud purposes, but no system account is created for the recipient. The verification is thus similar to a “mini-registration” process, although no ongoing relationship is established. It will be appreciated that, while the providing of funds to a viral recipient who elects not to register can be fairly described as a “one-time” or “one-off” transaction, the system of the invention permits such a recipient to receive funds repeatedly, without limit, except in those embodiments where the total number of unregistered receipts by a viral recipient is limited. In other embodiments, the size of a specific transfer can be limited, and/or the number of inbound transfers to a viral recipient within a specific time period (transaction “velocity”) can be limited. In addition, if a viral recipient has previously received funds through the system, the information previously provided through the ‘mini-registration’ process provides additional data for verifying the authenticity of the information provided on subsequent viral transactions, whether registered or unregistered.

If the recipient elects to receive his funds at an account maintained at a financial institution connected to the system of the present invention through either an EFT/ATM network or an association network, the funds are delivered to these respective banks 530 and 540 through their respective networks 535 and 545, at which point the funds are provided to the recipient. Such transfers occur in real time or near real time in at least some embodiments.

If the recipient elects to receive his funds via check, the system core 300 sends a message to a check processor 550, which in turn communicates with a check settlement institution 555. The funds are debited from a settlement account 560 connected to or otherwise associated with the system and maintained in that bank 555, as with the other settlement accounts described herein, and the check is generated for the user. Likewise, if the recipient elects to receive funds in his DDA account maintained at an institution accessible through the ACH, the system core 300 sends a message to an ACH settlement bank 565 through a processor 570, where a settlement account 580 is maintained. In some instances the recipient maintains his account at a bank or other financial institution 565A, in which case funds are transferred from the settlement bank to the bank. If the recipient elects to receive cash, the system core 300 sends a message to a cash agent 585, who in turn communicates to a settlement bank 590 where a settlement account 595, managed by system of the present invention is maintained, and cash is delivered to the recipient either directly or through a second cash agent 597.

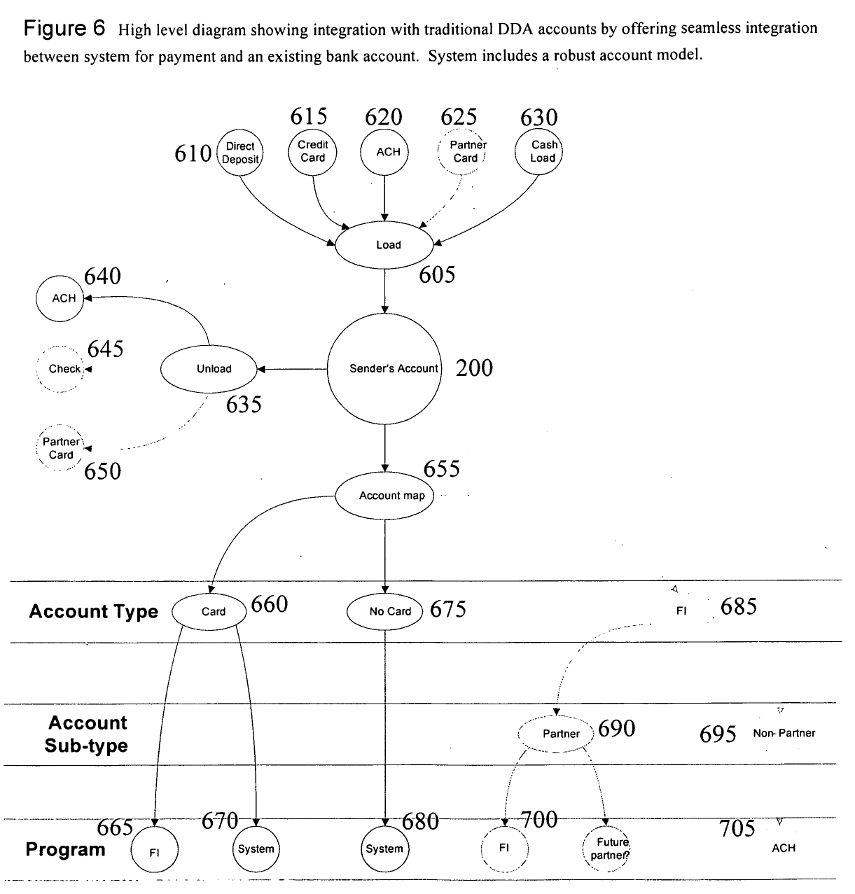

Referring next to FIG. 6, an embodiment is illustrated to permit an understanding of the relationships between the sender's mapped account and a variety of potential recipient accounts, including the intermediate institutions and account types participating in the funds exchange. It will be appreciated that FIG. 6 is, in many ways, a different representation of the system of FIG. 2. Thus, the sender's account 200 can be loaded, i.e., funds added, through a load process 605, and those funds can originate from a direct deposit 610, a credit card 615, an ACH transfer 620, a prepaid or other card 625 from a partner institution, or a cash payment 630. Similarly, the Sender can unload funds from his account 200 through an unload process 635 by which funds can be transferred to the sender via the ACH 640, a check 645, or a partner card 650.

If the sender is sending funds to a different entity, the sender supplies an identifier of the recipient as discussed in the '747 application. Depending upon the destination of the funds, an account map 665 either already knows the location of the recipient's account, or the system sends a message to the recipient and the recipient identifies where the funds should be sent as discussed in connection with FIGS. 1 and 2. Through either process, an account map either knows or learns sufficient information to initiate a process for delivering the funds to the recipient. At this point, the account map can point to any of three types of accounts. The first is a card-based account 660, either maintained at an integrated financial institution as indicated at 665 or within the system as indicated at 670. The second account type is a “no card” account, typically maintained within the system as indicated at 680. Third, the account can be maintained at an external financial institution 685, where that institution can either be a partner 690 or a non-partner 695. If a partner, the account is typically accessed through an integrated process with the financial institution, indicated at 700, whereas accounts maintained at non-partner institutions are typically accessed through ACH or similar processes, indicated at 705.

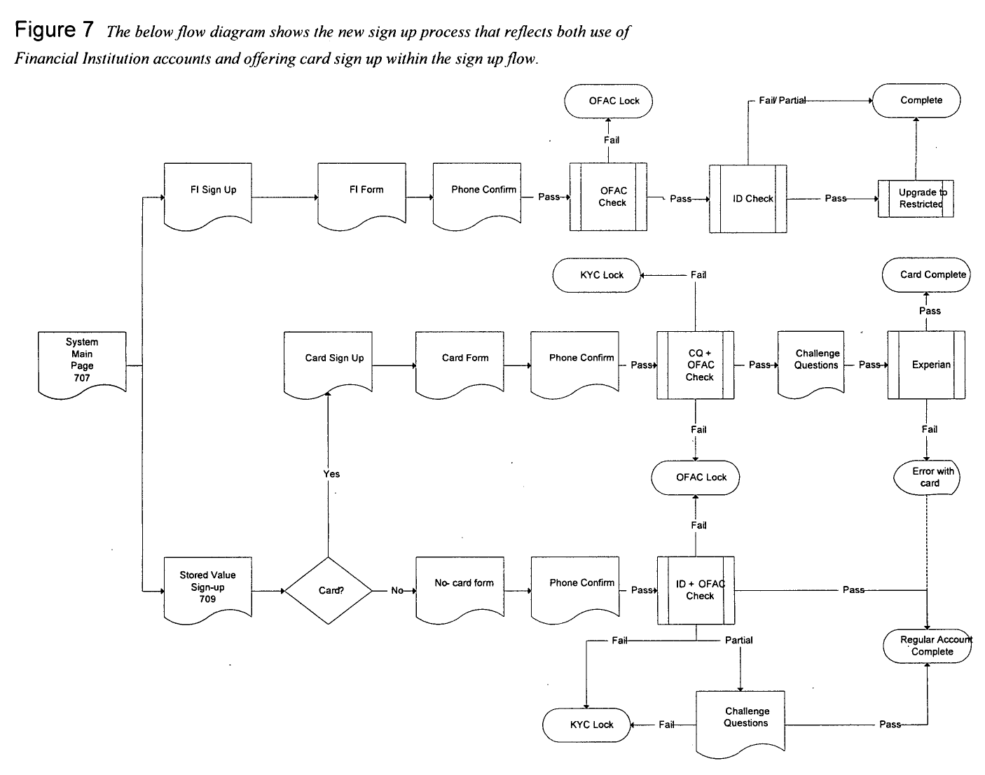

Referring next to FIG. 7, an embodiment of a process for signing up a new user is displayed, where the new user can either map to an account connected directly to the system, or can map to an account maintained at an external financial institution. To sign up, the prospective user accesses the system's main page, either through a mobile device, the internet, or other suitable connection, and is given a choice of mapping either to a DDA account or any other account maintained at a financial institution. Depending upon the user's selection, the process branches either to a prepaid sign-up sequence, or a financial institution sign-up sequence. The stored value sign-up begins at 709 and involves the choices of using a card or not, with appropriate confirmation, ID and OFAC (Office of Foreign Assets Control) checks, know your customer checks, and challenge questions, as discussed in the '747 application. If the user elects to choose a financial institution, the process continues at FI sign-up 711, where the user provides appropriate identification information at step 713, followed by a phone confirmation 715. Assuming the phone confirmation is successful, an OFAC check is performed at 717. If the OFAC check fails, the sign-up locks as shown at 719. If the OFAC check passes, an ID check is performed at 721. If the ID check fails, the process fails and completes as shown at 723. If the ID check passes, then the user is registered as shown at 725 and the process completes. In an embodiment, the privileges of the user at this point can be limited or restricted, as discussed further hereinafter.

In some embodiments, it is desirable to allow a user to receive a limited amount of money regardless of the result of the ID check. To achieve this, once the OFAC test is passed, all of signup process necessary to “receive” is complete. In such an embodiment, ID check requirements need not be enforced unless the user exceeds a predetermined limit on the amount of funds received, or exceeds a predetermined limit on the rate at which transfers occur, or the user attempts a restricted action. This arrangement has the advantage of not requiring a system account for the user.

If the user fails the ID check during registration, or partly fails, some embodiments limit the functions available to the new user. For example, in such an arrangement, the functions available to the new user can be limited to: account history, receiving money from friends, identifying payment methods, tracking money requests, inviting friends, tracking invitations, and so on. Other functions can be configured to cause an upgrade process to be initiated, requiring greater verification of ID. Such functions can include, for example and without limitation, adding money, attempt to auto-withdraw funds, sending money, withdrawing funds, cancelling money sent, attempting to add a bank account or editing the already-identified account, or applying for a card. It will be appreciated that different account privileges, comprising, for example, velocity threshold for the transfer of funds or other functional controls, will vary in some embodiments depending upon the level of ID verification performed, with greater privileges accorded to those whose ID's have been more thoroughly verified.

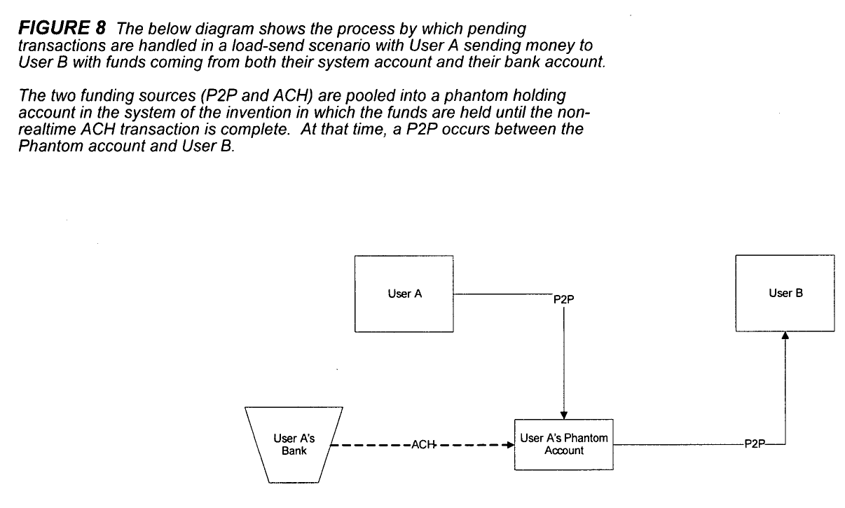

Referring next to FIG. 8, an embodiment of a transaction flow is shown wherein a sender is using funds from both a system account and a linked bank account to send funds to a recipient. More particularly, a user A has an account 800 linked to the system (a “system account”), and also has an account 805 accessible through the ACH. User A seeks to send money to User B, but requires funds from both accounts. The system creates a phantom account 810, and the funds from user A's system account are combined there with funds from his bank account (with appropriate delays for the ACH system), at which point a peer-to-peer transfer to user B can occur. It will be appreciated that the phantom account permits the transaction to be maintained in a “pending” state for a period while the funds are obtained from an ACH account.

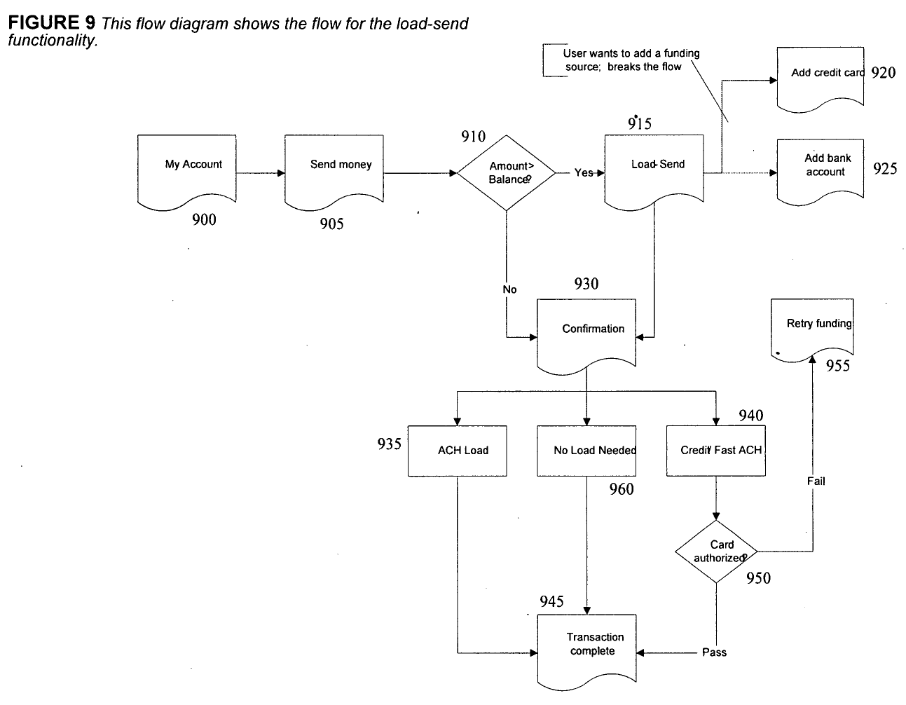

Referring next to FIG. 9, the load-send process is shown, including the ability of a registered user to add an account. The process starts at 900 at the user's account. The user determines to send funds, shown at 905, at which point a check of his balance is made as shown at 910. If the amount being sent is greater than the user's balance, the user is redirected to a “load funds” step, shown at 915. At this point, the user is permitted to add a link to a new funding source, such as a credit card as shown at 920, or a bank account as shown at 925. Once sufficient sources of funds have been identified, or if the balance was greater than the amount being sent at step 910, the process advances to a confirmation step, shown at 930, where the user is asked to confirm his intention to send funds, including loading funds if required. Once the confirmation is received, a funds load is attempted as shown at 935 and 940. If the funds load is using the ACH, the load occurs without further verification and the send portion of the transaction completes at 945. If funds are being loaded from a credit card, a card authorization step occurs at 950. If the load from a credit card is authorized, the transaction completes; if it fails, the user is asked to retry his funding at 955. If no load is needed, as shown at 960, the send is performed and the process completes.

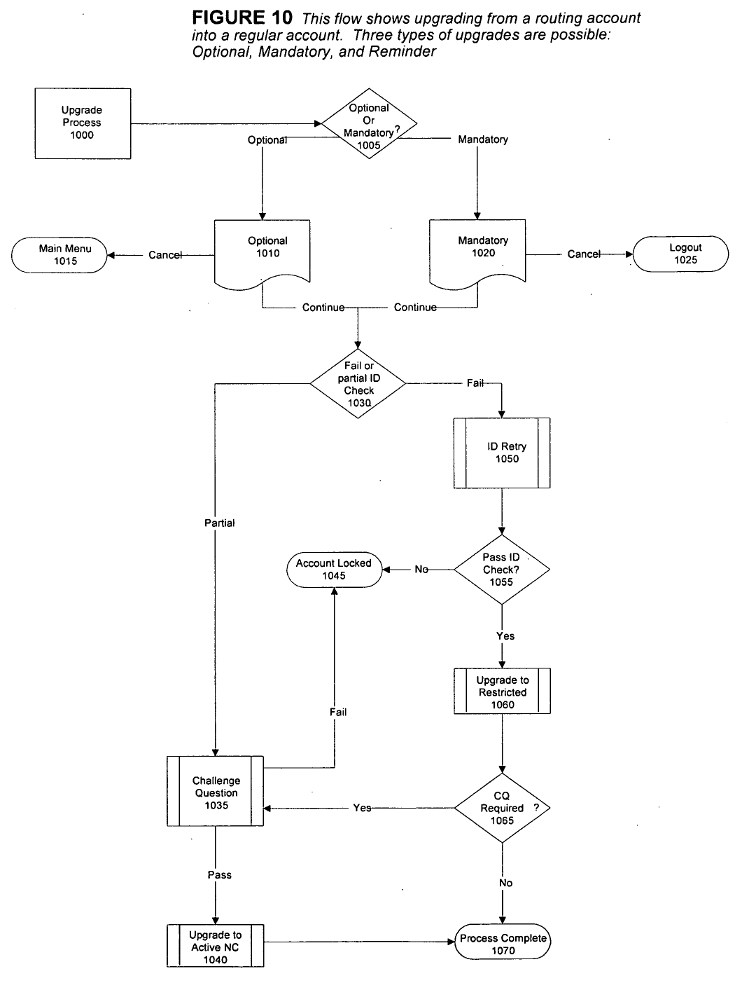

Referring next to FIG. 10, an embodiment of an upgrade process can be better appreciated. If the user chooses to upgrade, or performs any function that requires an upgrade, the user is take to step 1000 to begin the upgrade process. A check is made at 1005 to determine whether the upgrade is optional or mandatory. If optional, the user is permitted to cancel, at which time he is returned to the main menu, as shown at 1010 and 1015. If mandatory, shown at 1020, the user is logged out as shown at step 1025 if he attempts to cancel. If the user elects to continue, a check is made to determine whether the need for an upgrade is caused by an ID check fail, or merely a partial ID check, as at step 1030. If the cause is a partial ID check, the process advances to step 1035 and challenge questions are asked. If the user successfully answers the challenge questions, the verification of ID is successful and the user is upgraded to an active account status as shown at 1040. If the user fails to successfully answer the challenge questions, the account is locked, as shown at 1045.

If the cause of the upgrade was an earlier ID check failure, the ID check is retried at 1050 and 1055. If the new ID check fails again, the account is locked at 1045. If the new ID check passes, the account is upgraded to restricted as shown at 1060. A determination is then made as to whether challenge questions must be answered. If yes, the challenge questions are asked as at 1035 and 1040, discussed above. If not, the process completes as shown at 1070.

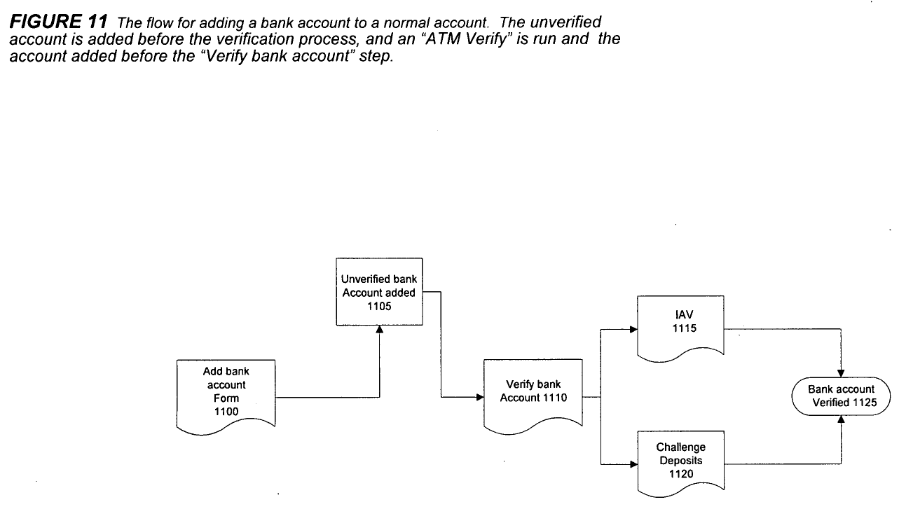

Referring next to FIG. 11, a process flow for adding a bank account is shown, which permits visibility of both verified and unverified accounts, although in an embodiment unverified accounts cannot be selected. The flow begins at 1100, where the “Add bank account” form is displayed for the user. Once the user enters the appropriate banking information, the bank account is added as “unverified”, shown at 1105. At that point, the newly added bank account is visible even if not accessible. The bank account is then verified, as shown at step 1110, either by an Instant Account Verification (IAV) process, shown at 1115, or by challenge deposits, shown at 1120, or by other techniques. Once the bank account is verified, shown at 1125, it is available to the user.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A system for performing value exchanges between a sender and a recipient comprising
an input queue adapted to receive value exchange requests, wherein the value exchange identifies a recipient and a value,
a system core connected to the input queue for validating value exchange requests and identifying whether the recipient is known, and
a message generator for sending a message to a recipient who is not known and requesting a response, whereby, depending upon the response, the system core authenticates the recipient without requiring registration, and securely transfers funds to the recipient.

2. A method for performing value exchanges between a sender and a recipient comprising the steps of
receiving from a sender via a network connection instructions to perform a value exchange with a recipient,
checking a database and determining whether the recipient is known,
if the recipient is not known, generating in a computer a message to the recipient requesting authentication of identity and sending the message to the recipient via a network connection,
depending upon the type of authentication provided, causing a computer system to transfer funds to the recipient in a manner designated by the recipient.
